(19) United States
(12) Patent Application Publication
(10) Pub. No.: US 2020/0318431 A1
(43) Pub. Date: Oct. 8, 2020

(54) Treestand Ladder Guard

(71) Applicant: Jason Allen DeLoe, Knox, PA (US)

(72) Inventor: Jason Allen DeLoe, Knox, PA (US)

(21) Appl. No.: 16/841,357

(22) Filed: Apr. 6, 2020

Related U.S. Application Data
(60) Provisional application No. 62/829,757, filed on Apr. 5, 2019.

(51) Int. Cl. E06C 7/00; E06C 1/04

(52) U.S. Cl. CPC E06C 7/006; A01M 31/02; E06C 1/04

(57) ABSTRACT

A treestand ladder guard includes a skeletal cover, an upper treestand ladder attachment, a lower treestand ladder attachment, and a chain. The skeletal cover includes a frame, a plurality of vertical bodies, and a plurality of horizontal bodies. The vertical bodies and the horizontal bodies are perpendicularly positioned of each other. The frame is perimetrically connected around the vertical bodies and the horizontal bodies thus completing the skeletal cover. The upper treestand ladder attachment is hingedly connected to a top end of the frame, and the lower treestand ladder attachment is hingedly connected to a bottom end of the frame thus securing the skeletal cover to the ladder of the treestand. The chain is terminally connected to the frame, opposite of the upper treestand ladder attachment and the lower treestand ladder attachment, so that the skeletal cover can be locked against the ladder of the treestand.

The current application claims a priority to the U.S. Provisional Patent application Ser. No. 62/829,757 filed on Apr. 5, 2019. The current application is filed on Apr. 6, 2020 while Apr. 5, 2020 was on a weekend.

### FIELD OF THE INVENTION

The present invention relates generally to protective devices of a treestand. More specifically, the present invention is a treestand ladder guard for an outdoor hunting treestand ladder.

### BACKGROUND OF THE INVENTION

In the sport of hunting, the treestand is used to give hunters an elevated vantage point from atop a tree. A higher vantage point allows a wider field of view to survey the environment for potential game. Generally, hunters are able to get up to the treestand by using a ladder that is mounted to the treestand. Unfortunately, due to the ladder of the treestand being left unattended for long periods of time, it can be frequently targeted by trespassers and thieves.

It is an objective of the present invention provides a solution to this problem by denying access to the treestand through the ladder. More specifically, the present invention is a treestand ladder guard that prevents trespassers and thieves from using the respective treestand while it is left unattended. The present invention hingedly connected to the treestand ladder from one end and while the opposite end can be selectively locked with the treestand ladder via a locking mechanism. Unless the locking mechanism is removed and the present invention is in an opened configuration, trespassers and thieves are not able to gain access to the treestand ladder.

### BRIEF DESCRIPTION OF THE DRAWINGS

FIG. 1 is a perspective view of the present invention, wherein the present invention is mounted to a treestand ladder and is in opened configuration.

FIG. 2 is a front view of the present invention, showing a detailed view that is taken shown in FIG. 3.

FIG. 3 is a detailed view of the skeletal cover of the present invention, showing the range of dimensions.

FIG. 4 is an exploded view of the upper treestand ladder attachment for the present invention.

FIG. 5 is an exploded view of the lower treestand ladder attachment for the present invention.

FIG. 6 is a perspective view of the present invention, wherein the present invention is mounted to a treestand ladder and is in closed configuration.

### DETAIL DESCRIPTIONS OF THE INVENTION

All illustrations of the drawings are for the purpose of describing selected versions of the present invention and are not intended to limit the scope of the present invention.

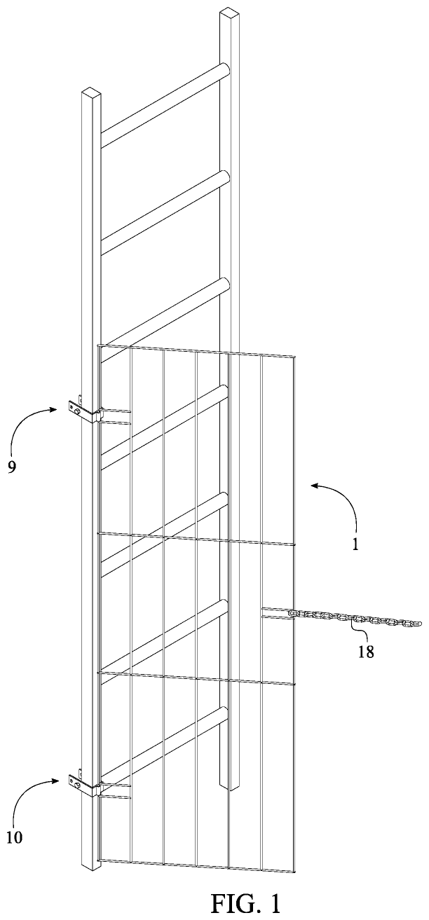

The present invention is a treestand ladder guard that prevents trespassers and thieves from using the respective treestand while it is left unattended. More specifically, the present invention is hingedly connected to the treestand ladder and is selectively locked against the treestand ladder thus blocking access to the treestand ladder. In reference to FIG. 1, the present invention comprises a skeletal cover 1, an upper treestand ladder attachment 9, a lower treestand ladder attachment 10, and a chain 18.

In reference to general configuration of the present invention, one end of the skeletal cover 1 is hingedly mounted to the treestand ladder through the upper treestand ladder attachment 9 and the lower treestand ladder attachment 10. As a result of the hinged connections, the skeletal cover 1 can move in between a closed configuration and an opened configuration. The chain 18 is connected to the opposite end of the skeletal cover 1 so that the chain 18 can be looped and locked around the treestand ladder to maintain the closed configuration of the skeletal cover 1. When the present invention at the opened configurations, an individual can access the treestand ladder and climbs up to the treestand. When the present invention at the closed configurations, an individual is not able to climb up to the treestand as the treestand ladder is blocked through the skeletal cover 1.

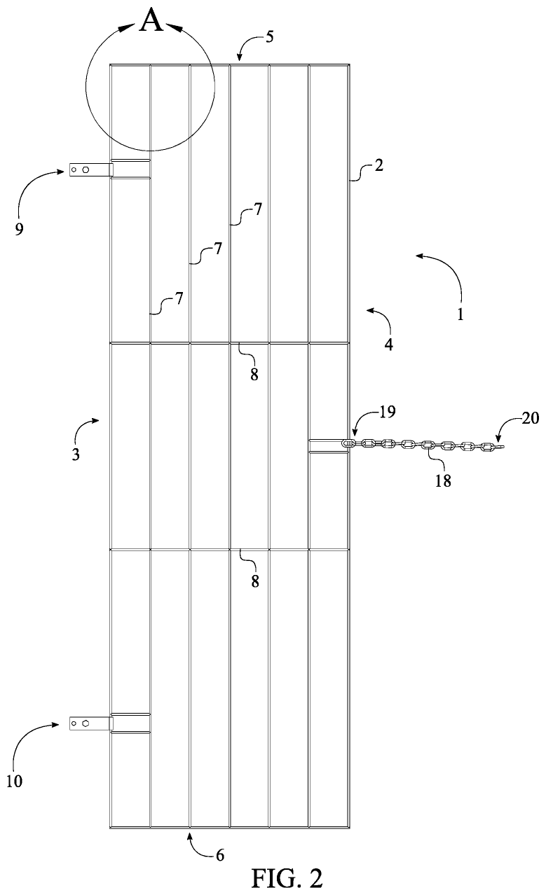

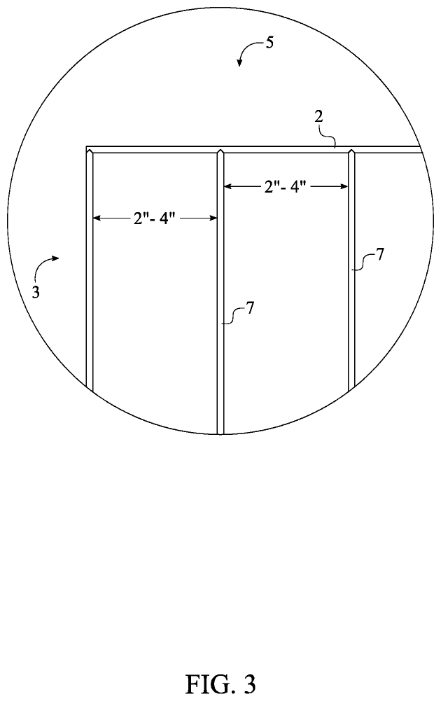

The skeletal cover 1 is a structural body that blocks access to the treestand ladder. The skeletal cover 1 comprises a frame 2, a plurality of vertical bodies 7, and a plurality of horizontal bodies 8 as shown in FIG. 2. More specifically, the skeletal cover 1 is preferably formed into a rectangular shape so that the treestand ladder can be vertically blocked. The plurality of vertical bodies 7 and the plurality of horizontal bodies 8 are perpendicularly connected to each other thus delineating the height and the width of the skeletal cover 1. The frame 2 is perimetrically connected around the plurality of vertical bodies 7 and the plurality of horizontal bodies 8 so that the outer profile of the skeletal cover 1 can be formed. In order to prevent an individual from using the skeletal cover 1 as a ladder, each of the plurality of vertical bodies 7 is closely positioned of each other. In reference to FIG. 3, a distance between the frame 2 and one of the plurality of vertical bodies 7 ranges from 2 inches to 4 inches. Furthermore, a distance between an arbitrary body of the plurality of vertical bodies 7 and a subsequent body of the plurality of vertical bodies 7 ranges from 2 inches to 4 inches. As a result, trespassers and thieves are not able to place their foot on one of the plurality of horizontal bodies 8 to use the skeletal cover 1 as a ladder to get up to the treestand.

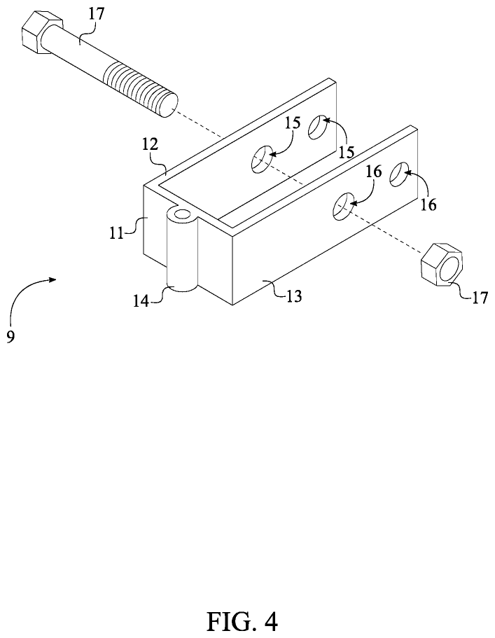

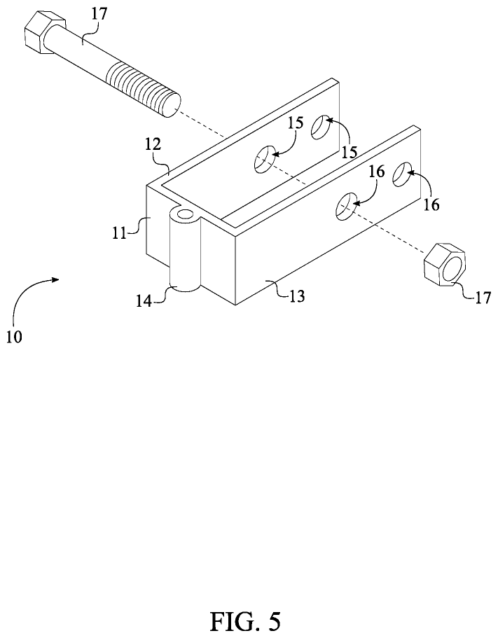

The upper treestand ladder attachment 9 is hingedly connected to a top end 5 of the frame 2, and the lower treestand ladder attachment 10 is hingedly connected to a bottom end 6 of the frame 2 so that the skeletal cover 1 can be hingedly mounted to the treestand ladder. In reference to FIG. 1, the upper treestand ladder attachment 9 and the lower treestand ladder attachment 10 provide two hinged connection so that the skeletal cover 1 can be firmly move in between the closed configuration and the opened configuration. In reference to FIG. 4-5, the upper treestand ladder attachment 9 and the lower treestand ladder attachment 10 each comprises a cross plate 11, a first leg 12, a second leg 13, and a sleeve body 14. The first leg 12 and the second leg 13 are oppositely positioned of each other about the cross plate 11 thus delineating a U-shaped bracket. More specifically, the first leg 12 and the second leg 13 are terminally connected to the cross plate 11 as the first leg 12 and the second leg 13 are able to sandwich a side rail of the treestand ladder. The sleeve body 14 is adjacently connected onto the cross plate 11 and oppositely positioned of the first leg 12 and the second leg 13. The sleeve body 14 is rotatably positioned around a hinged end 3 of the frame 2 so that the skeletal cover 1 can be hingedly secured to the cross plate 11 via the sleeve body 14. As a result, once the first leg 12 and the second leg 13 are secured to the side rail of the treestand ladder, the skeletal cover 1 is able to move in between the opened configuration and the closed configuration.

The sleeve body 14 is slightly larger in diameter than the hinged end 3 of the frame 2, which is preferably a cylindrical shaped body, so that the hinged end 3 can efficiently rotate within the sleeve body 14. Optionally, a friction reducing medium such a lubricant or a friction reducing apparatus such as a bearing can be placed in between the sleeve body 14 and the hinged end 3 to reduce the rotational friction of the skeletal cover 1.

The present invention can further comprise an upper stopper and a lower stopper to maintain a vertically stationary position for the sleeve body 14. More specifically, the upper stopper vertically stabilizes the sleeve body 14 of the upper treestand ladder attachment 9 so that the corresponding sleeve body 14 can be linearly secured along the hinged end 3 and rotatably positioned around the hinged end 3, adjacent to the top end 5. The lower stopper vertically stabilizes the sleeve body 14 of the lower treestand ladder attachment 10 so that the corresponding sleeve body 14 can be linearly secured along the hinged end 3 and rotatably positioned around the hinged end 3, adjacent to the bottom end 6.

The present invention further comprises at least one first opening 15, at least one second opening 16, and a ladder fastener 17 so that the upper treestand ladder attachment 9 and the lower treestand ladder attachment 10 can be secured to the side rail of the treestand ladder. In reference to FIG. 4-5, the first opening 15 traverses through the first leg 12. The second opening 16 traverses through the second leg 13, wherein the first opening 15 and the second opening 16 are concentrically positioned of each other. The ladder fastener 17, preferably a nut and bolt fastener, is removably engaged within the first opening 15 and the second opening 16 so that the ladder fastener 17, the cross plate 11, the first leg 12, and the second leg 13 are able to perimetrically bracket the side rail of the treestand ladder. In a preferred embodiment of the present invention, the at least one first opening 15 is a first pair of openings and the at least one second opening 16 is a second pair of openings. The first pair of openings and the second pair of opening provide two insertion openings for the ladder fastener 17 so that the positioning of the upper treestand ladder attachment 9 and the lower treestand ladder attachment 10 can be adjusted about the side rail of the treestand ladder.

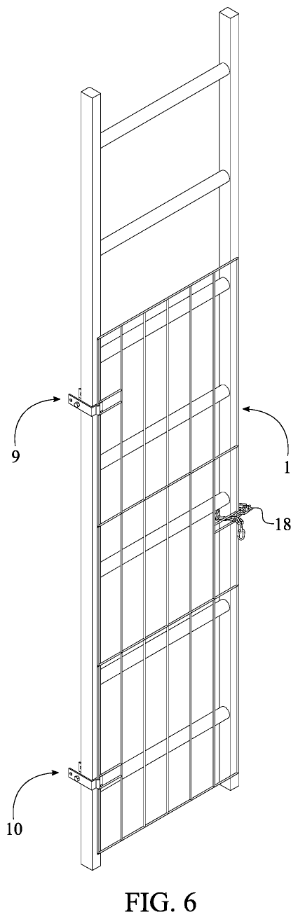

The chain 18 is terminally connected to the frame 2 and positioned opposite of the upper treestand ladder attachment 9 and the lower treestand ladder attachment 10. In other words, the chain 18 is configured in such way that the chain 18 can loop around an opposite side rail of the treestand ladder to keep the skeletal cover 1 at the closed configuration as shown in FIG. 6. More specifically, the chain 18 comprises a proximal end 19 and a distal end 20. The proximal end 19 is connected onto a free end 4 of the frame 2 as the hinged end 3 and the free end 4 are oppositely positioned of each other plurality of horizontal bodies 8. The distal end 20 is positioned opposite of the proximal end 19 about the chain 18, wherein the distal end 20 selectively loops around the opposite side rail of the treestand ladder and secured to the skeletal cover 1 through a locking apparatus such as padlock, combination lock, magnetic lock, or any other types of locks.

A preferred method of manufacturing for the present invention is described hereinafter. The hinged end 3 and the free end 4, ¼″×4′ iron bars, are first laid on a welding surface. The top end 5, the bottom end 6, and the plurality of horizontal bodies 8 are then positioned perpendicular to the hinged end 3 and the free end 4 to spot welded all of the intersecting points, wherein the top end 5, the bottom end 6, and the plurality of horizontal bodies 8 are ¼″×16″ iron bars. The distance between the top end 5, the bottom end 6, and each of the plurality of horizontal bodies 8 preferably ranges from 12″-18″. Then, ⅛″×4′ iron bars, the plurality of vertical bodies 7, are placed on top of the top end 5, the bottom end 6, and the plurality of horizontal bodies 8 to weld at all intersecting spots. The distance between each of the plurality of vertical bodies 7 is preferably ranges from 2″-4″. Then, a pair of ⅛″×2⅞″ iron bars are spot welded between the hinged end 3 and an adjacent vertical body of the plurality of vertical bodies 7 thus delineating the upper stopper as the distance between the upper stopper and the top end 5 is 6″. Then, another pair of ⅛″×2⅞″ iron bars are spot welded between the hinged end 3 and an adjacent vertical body of the plurality of vertical bodies 7 thus delineating the lower stopper as the distance between the lower stopper and the bottom end 6 is 6″. The chain 18 is 12″ and the proximal end 19 is spot welded to the free end 4, wherein the distance between the proximal end 19 the top end 5 is about 23″.

Although the invention has been explained in relation to its preferred embodiment, it is to be understood that many other possible modifications and variations can be made without departing from the spirit and scope of the invention as hereinafter claimed.

What is claimed is:

1. A treestand ladder guard comprising:
a skeletal cover;
an upper treestand ladder attachment;
a lower treestand ladder attachment;
a chain;
the skeletal cover comprising a frame, a plurality of vertical bodies, and a plurality of horizontal bodies;
the plurality of vertical bodies and the plurality of horizontal bodies being perpendicularly positioned of each other;
the frame being perimetrically connected around the plurality of vertical bodies and the plurality of horizontal bodies;
the upper treestand ladder attachment being hingedly connected to a top end of the frame;
the lower treestand ladder attachment being hingedly connected to a bottom end of the frame; and
the chain being terminally connected to the frame, opposite of the upper treestand ladder attachment and the lower treestand ladder attachment.

2. The treestand ladder guard as claimed in claim 1 comprising:
the upper treestand ladder attachment and the lower treestand ladder attachment each comprising a cross plate, a first leg, a second leg, and a sleeve body;
the first leg and the second leg being oppositely positioned of each other about the cross plate;
the first leg and the second leg being terminally connected to the cross plate;
the sleeve body being adjacently connected onto the cross plate;
the sleeve body being oppositely positioned of the first leg and the second leg; and
the sleeve body being rotatably positioned around a hinged end of the frame.

3. The treestand ladder guard as claimed in claim 2 comprising:
at least one first opening;
at least one second opening;
a ladder fastener;
the first opening traversing through the first leg;
the second opening traversing through the second leg; and
the ladder fastener being removably engaged within the first opening and the second opening.

4. The treestand ladder guard as claimed in claim 1 comprising:
the chain comprising a proximal end and a distal end;
the proximal end being connected onto the free end of the frame; and
the distal end being positioned opposite of the proximal end about the chain, wherein the distal end selectively loops around a treestand ladder and secured to the skeletal cover through a locking apparatus.

5. The treestand ladder guard as claimed in claim 1, wherein a distance between the frame and one of the plurality of vertical bodies ranges from 2 inches to 4 inches.

6. The treestand ladder guard as claimed in claim 1, wherein a distance between an arbitrary body of the plurality of vertical bodies and a subsequent body of the plurality of vertical bodies ranges from 2 inches to 4 inches.
